(19) United States
(12) Patent Application Publication
(10) Pub. No.: US 2026/0347203 A1
(43) Pub. Date: Nov. 5, 2026

(54) Nano-thin BixOySez low-temperature oxygen transporter membrane for oxygen transport, separation, and two-dimensional (2D) material manipulation

(71) Applicant: The Government of the United States of America, as represented by the Secretary of the Navy, Arlington, VA (US)

(72) Inventors: Zachariah B. Hennighausen, Newton, MA (US); Bethany Hudak, Accokeek, MD (US); Olaf M.J. Van 't Erve, Falls Church, VA (US); Madeleine Phillips, Alexandria, VA (US)

(73) Assignee: The Government of the United States of America, as represented by the Secretary of the Navy, Arlington, VA (US)

(21) Appl. No.: 19/735,147

(22) Filed: Jul. 8, 2026

Related U.S. Application Data
(62) Division of application No. 18/113,285, filed on Feb. 23, 2023.
(60) Provisional application No. 63/313,561, filed on Feb. 24, 2022.

(51) Int. Cl. C01G 29/00

(52) U.S. Cl. CPC C01G 29/00; C01P 2002/01; C01P 2002/20; C01P 2002/82; C01P 2004/20

(57) ABSTRACT

A nano-thin BiₓO_{y}Se_{z} low-temperature oxygen transporter membrane for oxygen transport, separation, and two-dimensional (2D) material manipulation comprising a material comprising a compound of BiₓO_{y}Se_{z} and R3̅m bismuth oxide (Bi₂O₃). A method of making a nano-thin BiₓO_{y}Se_{z} low-temperature oxygen transporter membrane for oxygen transport, separation, and two-dimensional (2D) material manipulation comprising providing an oxygen environment, providing Bi₂Se₃, processing the Bi₂Se₃ in the oxygen environment, incorporating oxygen, removing selenium, creating a structural change, and creating a compound of BiₓO_{y}Se_{z} and R3̅m bismuth oxide (Bi₂O₃), wherein the material transports oxygen at room temperature.

### REFERENCE TO RELATED APPLICATION

This application is a non-provisional of, and claims priority to and the benefits of, U.S. Provisional Patent Application No. 63/313,561 filed on Feb. 24, 2022, and U.S. patent application Ser. No. 18/113,285 filed on Feb. 23, 2023, the entirety of each is herein incorporated by reference.

### BACKGROUND

This disclosure concerns a process to fabricate a novel low-temperature oxygen transporter in nano-thin (1-5 nm) morphology.

Our material is a compound of BiₓO_{y}Se_{z} and R3̅m bismuth oxide (Bi₂O₃).

The material transports oxygen rapidly (3.11e-18 m²s⁻¹) at room temperature under low-power laser exposure. When combined with two-dimensional (2D) materials, the compound BiₓO_{y}Se_{z} and R3̅m Bi₂O₃ material can be used to controllably modulate the 2D material properties with high precision and spatial selectivity.

The changes to the 2D material are reversible and the material is reusable.

Our new material has potential to be used for a host of applications requiring oxygen transport membranes, including fuel cells and oxygen separation. Materials that enable rapid oxygen diffusion are becoming increasingly important as the world transitions to renewable energy. Oxygen transport membranes and oxygen ion conductors enable several technologies that manufacture carbon-neutral syngas and efficiently convert it into energy, solving a host of challenges where current battery technology is impractical, including long-duration and high-density energy storage.

Two-dimensional (2D) materials have demonstrated promise for a spectrum of applications, including superconductivity, quantum information science, DNA sequencing, catalysts, transistors, renewable energy, and COVID-19 sensing. Controlling the properties of the 2D material with high precision and spatial selectivity has the potential to advance these technologies.

Materials that enable rapid oxygen diffusion are becoming increasingly important as the world transitions to renewable energy. Oxygen transport membranes and oxygen ion conductors enable several technologies that manufacture carbon-neutral syngas and efficiently convert it into energy, solving a host of challenges where current battery technology is impractical, including long-duration and high-density energy storage.

We synthesized a nano-thin compound composed of a rare R3̅m bismuth oxide (Bi₂O₃) phase and BiₓO_{y}Se_{z}, which is able to rapidly transport oxygen at room-temperature under laser exposure (3.11e-18 m²s⁻¹). We combined BiₓO_{y}Se_{z} with monolayer TMDs, which have a strong light-matter coupling, bright PL, and are sensitive to the surrounding environment, enabling us to measure the oxygen transport speeds and demonstrate additional applications.

As oxygen is transported through the BiₓO_{y}Se_{z}, it fills the interlayer region, thereby modulating the monolayer TMD properties and brightening the PL. The oxygen can be controllably intercalated (deintercalated) to brighten (darken) the PL intensity, where the diffusion profile follows Fick's 2nd Law of Diffusion. Using laser-patterning, the diffusion can be controlled with submicron spatial resolution, where changes are stable for more than 221 days.

Our work indicates nano-thin BiₓO_{y}Se_{z} is a promising unexplored room-temperature oxygen transporter, raising the prospect that it can advance low-temperature SOFC technology and improve syngas production, thereby facilitating renewable energy. Additionally, we believe BiₓO_{y}Se_{z} and the interlayer intercalation mechanism can be applied generally to 2D materials to precisely manipulate their properties on the submicron scale, raising the possibility for a host of spatially-selective and tunable properties, including long-lived interlayer excitons, magnetism, and ferroelectricity.

Oxygen ion transport for solid oxide fuel cells (SOFCs). SOFCs are expected to play a critical role as the world transitions to clean and sustainable energy. SOFCs are not subject to Carnot cycle limitations, efficiently producing electricity without moving parts from direct fuel oxidation. Additionally, they are scalable, modular, low-noise, and can be operated in reverse to produce syngas and oxygen.

Purified Oxygen is required for numerous industrial and medical applications. Further, the demand for pure oxygen is expected to increase as the world transitions to renewable energy. The compound BiₓO_{y}Se_{z} and R3̅m Bi₂O₃ can improve efficiency and facilitate on-site oxygen production using modular units that employ membrane technology. This can be used to produce synthesis gas, which can be used to manufacture carbon-neutral and renewable liquid hydrocarbons. These have demonstrated potential as carbon-neutral fuels for long-duration and high-density energy storage, solving a host of challenges where current battery technology is impractical, including (1) intermittent and seasonal energy production; (2) long refueling times; and (3) heavy-duty and long-distance transportation (e.g., buses, trucks, trains, forklifts, and ships).

The technology can be applied to power generation exhaust to efficiently remove excess unreacted oxygen, thereby increasing the concentration of exhaust pollutants for more efficient carbon and pollutant capture.

The material can be applied as an oxygen carrier in a biomass chemical looping gasification system to produce carbon-neutral syngas.

Our approach modulates the properties of 2D material with high precision and spatial selectivity. The changes to the 2D material are reversible and the material is reusable. They have demonstrated application in a spectrum of disciplines, including superconductivity, quantum information science, DNA sequencing, catalysts, transistors, renewable energy, and COVID-19 sensing. Additionally, 2D materials have demonstrated promise for a host of advanced computing schemes, including valleytronics, twistronics, spintronics, neuromorphic computing, and quantum computing.

### SUMMARY OF DISCLOSURE

### Description

This disclosure concerns a process to fabricate a novel low-temperature oxygen transporter in nano-thin (1-5 nm) morphology.

Our material is a compound of BiₓO_{y}Se_{z} and R3̅m bismuth oxide (Bi₂O₃).

The material transports oxygen rapidly (3.11e-18 m²s⁻¹) at room temperature under low-power laser exposure. When combined with two-dimensional (2D) materials, the compound BiₓO_{y}Se_{z} and R3̅m Bi₂O₃ material can be used to controllably modulate the 2D material properties with high precision and spatial selectivity.

The changes to the 2D material are reversible and the material is reusable.

We synthesized a nano-thin compound composed of a rare R3̅m bismuth oxide (Bi₂O₃) phase and BiₓO_{y}Se_{z}, which is able to rapidly transport oxygen at room-temperature under laser exposure (3.11e-18 m²s⁻¹). We combined BiₓO_{y}Se_{z} with monolayer TMDs, which have a strong light-matter coupling, bright PL, and are sensitive to the surrounding environment, enabling us to measure the oxygen transport speeds and demonstrate additional applications.

As oxygen is transported through the BiₓO_{y}Se_{z}, it fills the interlayer region, thereby modulating the monolayer TMD properties and brightening the PL. The oxygen can be controllably intercalated (deintercalated) to brighten (darken) the PL intensity, where the diffusion profile follows Fick's 2nd Law of Diffusion. Using laser-patterning, the diffusion can be controlled with submicron spatial resolution, where changes are stable for more than 221 days.

### DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings.

FIG. 1 illustrates Laser-oxygen exposure facilitates BiₓO_{y}Se_{z} transformation, enabling oxygen intercalation and deintercalation at 2D material interface. Schematic showing spatially selective transformation of few-layer Bi₂Se₃ into nano-thin R3̅m Bi₂O₃ and BiₓO_{y}Se_{z} using a laser in air at room temperature. During laser exposure, oxygen is incorporated and selenium is removed. Regions of the laser exposed area are converted into a rare R3̅m Bi₂O₃ phase. Bismuth oxides are a class of materials well known for their high oxygen ion conductance. We demonstrated that BiₓO_{y}Se_{z} can be used to precisely modulate the properties of 2D materials with high spatial selectivity. Regulating the quantity of intercalated oxygen between BiₓO_{y}Se_{z} and the 2D material modulates the coupling between the materials and the 2D material properties.

FIG. 2 illustrates Site-selective BixOySez fabrication on TEM mesh support reveals stoichiometric changes. Schematic showing monolayer Bi2Se3 on a TEM mesh support. Raman spectra measured during laser exposure in air reveal the characteristic Bi2Se3 peaks decrease, suggesting the material is being disrupted. Optical image of Bi2Se3 on a TEM mesh support laser-patterned in air. Laser-oxygen exposure induces a prominent color change. Corresponding STEM-EDS maps. Where Bi2Se3 was exposed to the laser in air, the concentration of oxygen increases, while selenium decreases.

FIG. 3 illustrates Selected area electron diffraction (SAED) analysis of pristine Bi2Se3 and Bi2O3 formed through laser exposure. SAED from pristine multi-layer Bi2Se3, which matches well with the calculated Bi2Se3 pattern. Inset: HAADF image of pristine Bi2Se3. SAED of Bi2Se3 region exposed to laser compared to calculated Bi2Se3 and Bi2O3 diffraction patterns. The experimental pattern matches closely with the calculated Bi2O3 structure. HAADF image from which the SAED was acquired. Circle indicates the position of the selected-area aperture. EDS map of O and Se from the region. EDS indicates a decrease in Se and increase in O. Optimized lattice constants of Bi2Se3 and related materials, as Se is systematically replaced with O and R3̅m structure is maintained.

FIG. 4 illustrates Fabricating BixOySez-WSe2 2D heterostructure. Schematic of a Bi2Se3-WSe2 2D heterostructure grown on SiO2 using CVD. As-grown Bi2Se3-WSe2 2D heterostructure is illustrated. Optical image is illustrated. Background is SiO2. AFM scan and corresponding line profile showing 3-layers Bi2Se3 were grown on 1-layer WSe2. Selected area electron diffraction (SAED) image showing Bi2Se3 prefers to grow at a ~0° twist angle on WSe2. As-grown Bi2Se3-WSe2 was laser-patterned in air with the letters “NRL”, inducing spatially selective transformation of BixOySez-WSe2. BixOySez is confined to the laser spot, where the expected color change to be readily observed. The color change is due to BixOySez and independent of the concentration of intercalated oxygen. Raman spectra of three configurations: as-grown Bi2Se3-WSe2, and BixOySez-WSe2 with both oxygen absorbed and oxygen desorbed. During BixOySez transformation, Bi2Se3 peaks significantly diminish (see FIG. 2). Conversely, the WSe2 and Si peaks increase a factor ×2, possibly due to the greater optical transmission through BixOySez.

FIG. 5 illustrates Monolayer Bi2Se3 quenches bright monolayer WSe2 PL. Optical image showing well-formed triangular Bi2Se3 crystals grown on monolayer WSe2. Bi2Se3 triangles grow aligned with WSe2, in agreement with SAED. AFM scan and corresponding line profile shows Bi2Se3 triangles are one quintuple layer (1 nm) tall. Blue line corresponds to the location of the line profile. Fluorescence image showing monolayer Bi2Se3 quenches the bright WSe2 PL, suggesting the strong electronic coupling induces a non-radiative exciton recombination pathway.

### DETAILED DESCRIPTION OF THE INVENTION

This disclosure concerns a process to fabricate a novel low-temperature oxygen transporter in nano-thin (1-5 nm) morphology.

Our material is a compound of BiₓO_{y}Se_{z} and R3̅m bismuth oxide (Bi₂O₃).

The material transports oxygen rapidly (3.11e-18 m²s⁻¹) at room temperature under low-power laser exposure. When combined with two-dimensional (2D) materials, the compound BiₓO_{y}Se_{z} and R3̅m Bi₂O₃ material can be used to controllably modulate the 2D material properties with high precision and spatial selectivity.

The changes to the 2D material are reversible and the material is reusable.

We synthesized a nano-thin compound composed of a rare Rim bismuth oxide (Bi₂O₃) phase and BiₓO_{y}Se_{z}, which is able to rapidly transport oxygen at room-temperature under laser exposure (3.11e-18 m²s⁻¹). We combined BiₓO_{y}Se_{z} with monolayer TMDs, which have a strong light-matter coupling, bright PL, and are sensitive to the surrounding environment, enabling us to measure the oxygen transport speeds and demonstrate additional applications.

As oxygen is transported through the BiₓO_{y}Se_{z}, it fills the interlayer region, thereby modulating the monolayer TMD properties and brightening the PL. The oxygen can be controllably intercalated (deintercalated) to brighten (darken) the PL intensity, where the diffusion profile follows Fick's 2nd Law of Diffusion. Using laser-patterning, the diffusion can be controlled with submicron spatial resolution, where changes are stable for more than 221 days.

Our work indicates nano-thin BiₓO_{y}Se_{z} is a promising unexplored room-temperature oxygen transporter, raising the prospect that it can advance low-temperature SOFC technology and improve syngas production, thereby facilitating renewable energy. Additionally, we believe BiₓO_{y}Se_{z} and the interlayer intercalation mechanism can be applied generally to 2D materials to precisely manipulate their properties on the submicron scale, raising the possibility for a host of spatially-selective and tunable properties, including long-lived interlayer excitons, magnetism, and ferroelectricity.

Oxygen ion transport for solid oxide fuel cells (SOFCs). SOFCs are expected to play a critical role as the world transitions to clean and sustainable energy. SOFCs are not subject to Carnot cycle limitations, efficiently producing electricity without moving parts from direct fuel oxidation. Additionally, they are scalable, modular, low-noise, and can be operated in reverse to produce syngas and oxygen.

Purified Oxygen is required for numerous industrial and medical applications. Further, the demand for pure oxygen is expected to increase as the world transitions to renewable energy. The compound BiₓO_{y}Se_{z} and R3̅m Bi₂O₃ can improve efficiency and facilitate on-site oxygen production using modular units that employ membrane technology. This can be used to produce synthesis gas, which can be used to manufacture carbon-neutral and renewable liquid hydrocarbons. These have demonstrated potential as carbon-neutral fuels for long-duration and high-density energy storage, solving a host of challenges where current battery technology is impractical, including (1) intermittent and seasonal energy production; (2) long refueling times; and (3) heavy-duty and long-distance transportation (e.g., buses, trucks, trains, forklifts, and ships).

The changes to the 2D material are reversible and the material is reusable.

We synthesized a nano-thin compound composed of a rare R3̅m bismuth oxide (Bi₂O₃) phase and BiₓO_{y}Se_{z}, which is able to rapidly transport oxygen at room-temperature under laser exposure (3.11e-18 m²s⁻¹). We combined BiₓO_{y}Se_{z} with monolayer TMDs, which have a strong light-matter coupling, bright PL, and are sensitive to the surrounding environment, enabling us to measure the oxygen transport speeds and demonstrate additional applications.

As oxygen is transported through the BiₓO_{y}Se_{z}, it fills the interlayer region, thereby modulating the monolayer TMD properties and brightening the PL. The oxygen can be controllably intercalated (deintercalated) to brighten (darken) the PL intensity, where the diffusion profile follows Fick's 2nd Law of Diffusion. Using laser-patterning, the diffusion can be controlled with submicron spatial resolution, where changes are stable for more than 221 days in our novel oxygen transport material: Nano-thin compound containing R3̅m bismuth oxide (Bi2O3) phase and BixOySez.

Oxygen transporters and ion conductors—materials that facilitate rapid oxygen diffusion—enable key technologies that are expected to play a critical role as the world transitions to clean and renewable energy, including solid oxide fuel cells (SOFCs) and synthesis gas (syngas) production.

SOFCs are not subject to Carnot cycle limitations, efficiently producing electricity without moving parts from direct fuel oxidation. Additionally, they are scalable, modular, low-noise, and can be operated in reverse to produce syngas and oxygen. Oxygen transport membranes and oxygen carriers can also be applied in other processes to produce carbon-neutral syngas using biomass or solar heating. Syngas, and its conversion to liquid hydrocarbons, has demonstrated potential as a carbon-neutral fuel for long-duration and high-density energy storage, solving a host of challenges where current battery technology is impractical, including (1) intermittent and seasonal energy production; (2) long refueling times; and (3) heavy-duty and long-distance transportation (e.g., buses, trucks, trains, forklifts, and ships). A critical limitation of SOFCs are the high operating temperatures (~800 °C), which decrease lifetime and increase start-up times, constraining greater adoption.

In this work, we synthesized a novel nano-thin oxygen transporter composed of a rare R3̅m bismuth oxide (Bi2O3) phase and BixOySez.

Our findings demonstrate it is able to rapidly diffuse oxygen at room temperature under laser exposure.

Bismuth oxide-based materials have demonstrated exceptional oxygen transport and ion conducting properties, and are a leading material for advanced SOFCs and oxygen separation membranes.

Additionally, they have demonstrated promise for spectrum of technologies, including photocatalysts, multiferroics, and gas sensors.

### Example 1

To synthesize nano-thin R3̅m Bi2O3 and BixOySez, we laser processed few-layer Bi2Se3 in an oxygen environment, which facilitates the steady incorporation of oxygen, removal of selenium, and a structural change. The precursor Bi2Se3 is grown using either chemical vapor deposition (CVD) or molecular-beam epitaxy (MBE), suggesting the process is economically scalable, providing a route to application.

### Example 2

Nano-thin BixOySez can modulate 2D material properties.

We demonstrated oxygen transport through nano-thin BixOySez by combining it with monolayer transition metal dichalcogenides (TMDs), whose properties are sensitive to the adjacent environment.

We were able to controllably transport oxygen into and out of the interlayer region, thereby reversibly modulating the 2D material's properties higher and lower with high precision.

Further, the changes are confined to the laser spot, enabling submicron patterning.

Our findings indicate BixOySez and the mechanism can be applied to other 2D materials as a generalized method to reversibly and precisely manipulate the properties with submicron spatial resolution.

Two-dimensional (2D) materials have made a notable impact across numerous disparate fields, including superconductivity, quantum information science, DNA sequencing, catalysts, transistors, renewable energy, and COVID-19 sensing. 2D Materials are highly sensitive to their environment, providing a pathway to modulate their properties across wide ranges and tailor them to specific applications. Monolayer TMDs have demonstrated particular promise, in part due to their strong light-matter interaction, stable valley polarization, and bright photoluminescence (PL). Additionally, they contain tightly-bound excitons, which can reside at different valleys within the band structure, due in part to broken inversion symmetry and spin-orbit coupling. These valleys, and excitons therein, can be selectively addressed using circularly polarized light, enabling a host of advanced computing schemes, including valleytronics, twistronics, spintronics, and quantum computing.

### Example 3

Here, we combined BixOySez with different monolayer TMDs (i.e., WSe2 and WS2) to form 2D heterostructures, whose PL can be reversibly modulated using controlled oxygen intercalation and deintercalation into the interlayer region. As oxygen is intercalated (deintercalated), the PL is brightened (darkened), due to changing exciton recombination pathways. The PL evolution follows Fick's 2nd Law of Diffusion, enabling us to measure the oxygen diffusion speed through the BixOySez.

Our findings indicate oxygen diffuses very fast through BixOySez at room temperature under laser exposure (3.11e-18m¬2s−1), raising the prospect that it could advance low-temperature SOFC technology and improve syngas production.

Separately, our work suggests BixOySez can be applied generally to 2D materials to precisely manipulate their properties on the submicron scale, raising the possibility for a host of spatially-selective and tunable properties, including long-lived interlayer excitons, magnetism, and ferroelectricity.

### Example 4

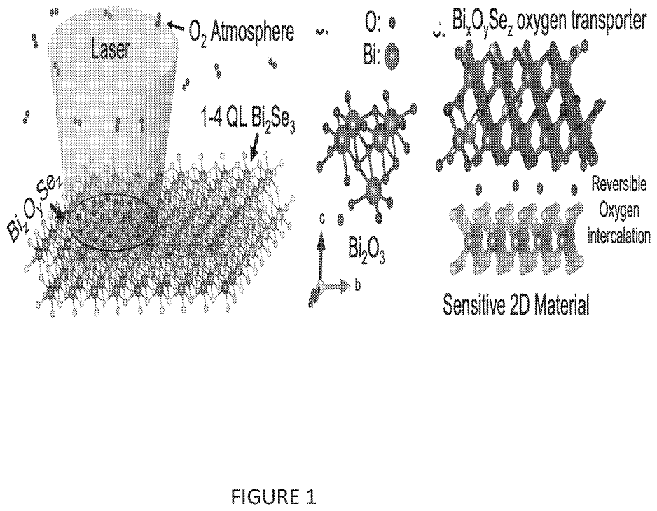

Our findings indicate laser exposure in an oxygen atmosphere converts few-layer Bi2Se3 into a nano-thin compound containing a rare R3̅m Bi2O3 phase and BixOySez (FIG. 1). FIG. 1 shows the R3̅m Bi2O3 phase. Previous work reported bulk rhombohedral Bi2O3, although it needed to be stabilized using dopants or a substrate.

Our work indicates R3̅m Bi2O3 is stable in ambient as a nano-thin film.

FIG. 1 illustrates BixSeyOz facilitating the transport of oxygen into the interlayer region, thereby modifying the 2D material environment and its coupling to BixSeyOz. More specifically, when oxygen is absent (present), the materials are coupled (uncoupled), modifying the material's properties and exciton recombination pathways. Previous work showed that the interlayer coupling strength of layered materials can be modulated by intercalating oxygen or other compounds.

### Example 5

### Material Growth and Fabrication Steps

Below are the fabrication steps for BixOySez.

We demonstrated BixOySez can be fabricated by numerous different methods. Importantly, BixOySez requires a precursor Bi2Se3, which is grown prior to laser-oxygen processing, which is the final fabrication step where the selenium is mostly removed and oxygen is incorporated.

### Example 6

Material Growth—Few-Layer Bi2Se3 on Sapphire The Bi2Se3 films were grown on 10×10 mm2 c-plane (0001) sapphire (Al2O3) substrates using molecular beam epitaxy (MBE) with base pressure below 5×10−10 Torr. The substrates were initially annealed ex-situ at 1,000 °C under the atmospheric pressure, and ozone cleaned in-situ under 200 Torr of oxygen pressure.

It is then annealed at 600 °C for 20 min in the ultra-high vacuum MBE chamber. Individual sources of high-purity (99.999%) Bi and Se were evaporated from standard effusion cells during the film growth.

Se flux was maintained at least ten times higher than Bi's to minimize Se vacancies.

To obtain an atomically sharp interface between the Bi2Se3 layer and the substrate, we adopted the two-step growth scheme. First, the initial 3 QL Bi2Se3 is grown at 170 °C. It is slowly annealed to 300 °C, and followed by deposition of the remaining 2QL Bi2Se3 layers. 5QL Bi2Se3 was grown.

### Example 7

### Material Growth—Bi2Se3 on a TMD

Monolayer TMDs are synthesized at ambient pressure in 2-inch diameter quartz tube furnaces on SiO2/Si substrates (275 nm thickness of SiO2).

Separate dedicated furnaces are used for the growth of WS2 and WSe2 to prevent cross contamination. Prior to use, all SiO2/Si substrates are cleaned in acetone, IPA, and Piranha etch (H2SO4+H2O2) then thoroughly rinsed in DI water. At the center of the furnace is positioned a quartz boat containing ~lg of WO3 powder. Two SiO2/Si wafers are positioned face-down, directly above the oxide precursor. A separate quartz boat containing the appropriate chalcogen powder (S or Se) is placed upstream, outside the furnace-heating zone, for the synthesis of WS2 or WSe2.

The upstream SiO2/Si wafer contains perylene-3,4,9,10-tetracarboxylic acid tetrapotassium salt (PTAS) seeding molecules, while the downstream substrate is untreated. The hexagonal PTAS molecules are carried downstream to the untreated substrate and promote lateral growth of the monolayer TMD.

Pure argon (65 sccm) is used as the furnace heats to the target temperature. Upon reaching the target temperature in the range of 825 to 875 °C, 10 sccm H2 is added to the Ar flow and maintained throughout the 10-minute soak and subsequent cooling to room temperature.

### Example 8

Bi2Se3 was grown on top of the monolayer TMDs (i.e., WS2 and WSe2) using chemical vapor deposition (CVD) in a two-zone furnace with a 2″ quartz tube.

High-purity Bi2Se3 flakes are ground using a mortar and pestle into a fine dust. The powdered Bi2Se3 is placed in a ceramic boat and inserted into the furnace's quartz tube, and pushed into the center of the furnace's first zone. The monolayer TMD, which is on an SiO2 substrate, is placed downstream of the Bi2Se3 into the center of the furnace's second zone. The furnace is pumped down to ~20 mTorr. An argon (Ar) carrier gas is flown into the furnace at 80 sccm.

The Bi2Se3 is heated to 520 °C (550 °C), and the WS2 (WSe2) are heated to 210 °C (245 °C). The ramp rate is ~55 °C/min, and the total growth is 27 min (14 min).

### Example 9

Laser-Oxygen Processing and Heat Processing to Transform Bi2Se3 into BixOySez.

Applied a low-power 532 nm laser (>2.7 μW and >0.12 μW/μm2) in an environment containing oxygen, transformed Bi2Se3 into BixOySez.

The process can be done with any laser, so long as sufficient energy is imparted to raise the temperature of the sample, enabling transformation.

Our work indicates that the same transformation process is possible using heating using a conventional oven in an environment containing oxygen. The partial pressure of the oxygen and laser power determine the rate of transformation, where higher partial pressure and higher powers increase the rate of transformation.

Our work indicates that heating can be substituted for laser power.

### Example 10

### Demonstration and Characterization of BixOySez

BixOySez was fabricated on a TEM mesh support, and studied using Raman spectroscopy and scanning transmission electron microscopy energy-dispersive X-ray spectroscopy (STEM-EDS).

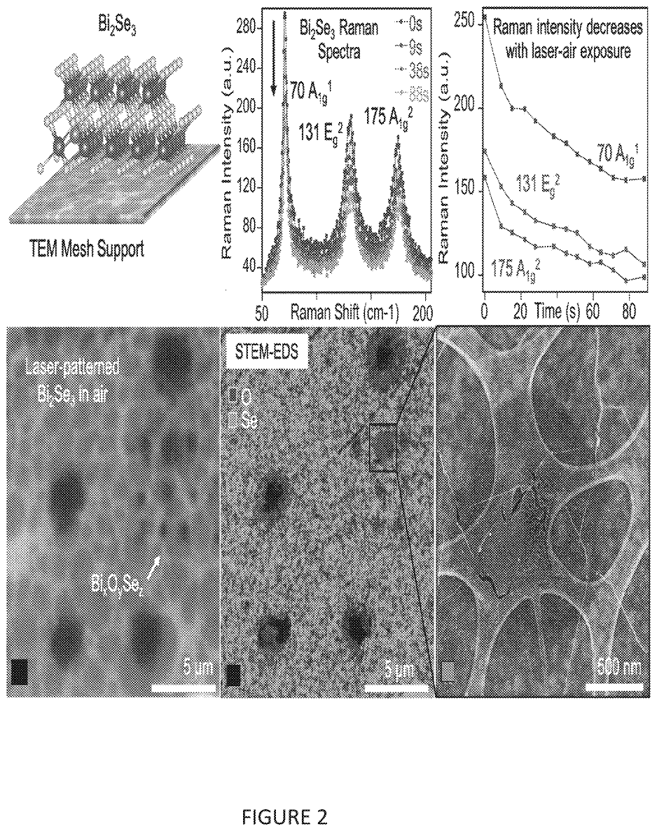

Few-layer Bi2Se3—the BixOySez precursor—was grown using molecular beam epitaxy (MBE) and transferred onto a TEM mesh support (see methods). Raman spectroscopy reveals peaks characteristic of few-layer Bi2Se3 (FIG. 2).

During laser-air exposure, all the peaks decreased intensity (FIG. 2), suggesting the BiSe3 was being disrupted. FIG. 2 shows an optical image of BixOySez laser-patterned into Bi2Se3, where the white “webbing” is from the TEM mesh support and the dark spots are BixOySez.

Our findings indicate BixOySez exhibits a distinct color from Bi2Se3, enabling laser-patterned areas to be easily identified.

### Example 11

FIG. 2 shows the same region from FIG. 2 with the oxygen and selenium content mapped via STEM-EDS. Four holes were drilled into the Bi2Se3 under laser-oxygen exposure to provide unambiguous identification of the region of interest in the STEM.

At the edge of each of these holes, we see a clear increase in the oxygen content with a corresponding decrease in selenium. The laser-oxygen-exposed 3×3 grid is also readily observed by the increased oxygen content. FIG. 2 shows a higher magnification STEM-EDS map of a single spot from the grid, with an approximately 1 m diameter circle containing a large amount of oxygen and small amount of selenium. The “webbed” pattern visible is the lacey carbon support on the TEM grid. The shape and size of this spot corresponds well with the laser size.

Using the STEM-EDS map in FIG. 2, we calculate an 87% decrease in Se—from 23 at. % to 3 at. %—and an 47% increase in O—from 57 at. % to 84 at. %—between the surrounding film and the laser-exposed spot.

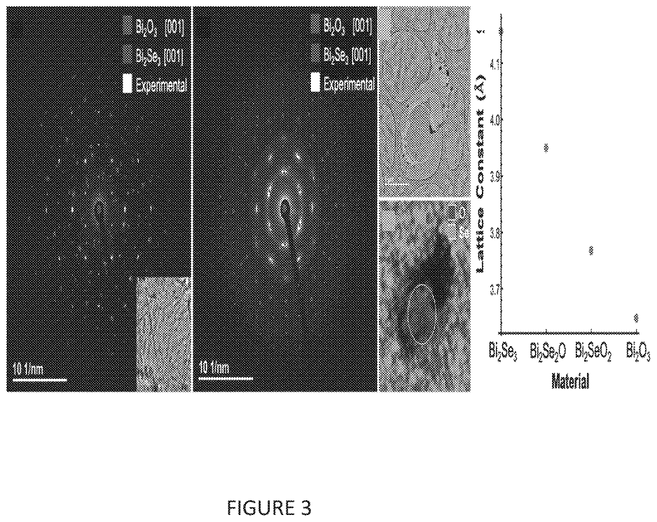

The change in oxygen (O) and selenium (Se) content correlates with a change in the crystal lattice. FIG. 3 shows selected area electron diffraction (SAED) taken from two regions of the film: a pristine Bi2Se3 region (FIG. 3) and a laser-oxygen exposed region (FIG. 3). The pristine Bi2Se3 region was located on the TEM grid several grid-squares away from the laser-exposed region and therefore we can confidently assume it was not impacted by the laser. The SAED pattern of the Bi2Se3 shows two sets of spots, indicating a twist among the layers.

As shown in FIG. 3, the SAED pattern matches well with the calculated R3̅m Bi2Se3 pattern using first-principles density functional theory (DFT) (see methods). FIG. 3 shows an SAED pattern from a laser-oxygen exposed spot. The circle in FIG. 3 shows the position of the SAED aperture, and a significant increase in O can be seen from the STEM-EDS map (FIG. 3). The SAED pattern of this region has a smaller lattice constant than Bi2Se3, and the crystal structure matches well with R3̅m Bi2O3.

The SAED data combine with the STEM-EDS data strongly indicates that the laser-oxygen exposure of the Bi2Se3 is removing Se atoms and replacing them with O atoms, resulting in the production of BixOySez.

STEM-EDS maps of the laser/air exposed Bi2Se3 (FIG. 2) show a significant reduction in selenium and an increase in oxygen.

Furthermore, the SAED images show that after laser-air exposure, the hexagonal symmetry of the sample is maintained, while the lattice constant decreases (FIG. 3).

These combined results suggest that Se is being removed from the lattice and replaced with oxygen.

To explore this possibility, we used DFT to optimize the lattice constants of a series of monolayer Bi2Se3 crystals in which the selenium atoms are systematically replaced with oxygen atoms (FIG. 3). The crystal structure of Bi2Se3 R3̅m is maintained for each calculation. The structure that most nearly matches the SAED results is the monolayer Bi2O3. Inspection of the phonon modes of Bi2O3 with the R3̅m crystal structure shows that this structure is not predicted to be stable at OK. However, previous work experimentally demonstrated bulk rhombohedral Bi2O3 using dopants and substrates, raising the possibility that a combination of structural, chemical, and environmental factors is stabilizing the rare Bi2O3 phase in our experiments. For example, several other Bi2O3 phases, such as δ-Bi2O3, only stabilize above certain temperatures.

Demonstration and Characterization of BixOySez with a 2D Material

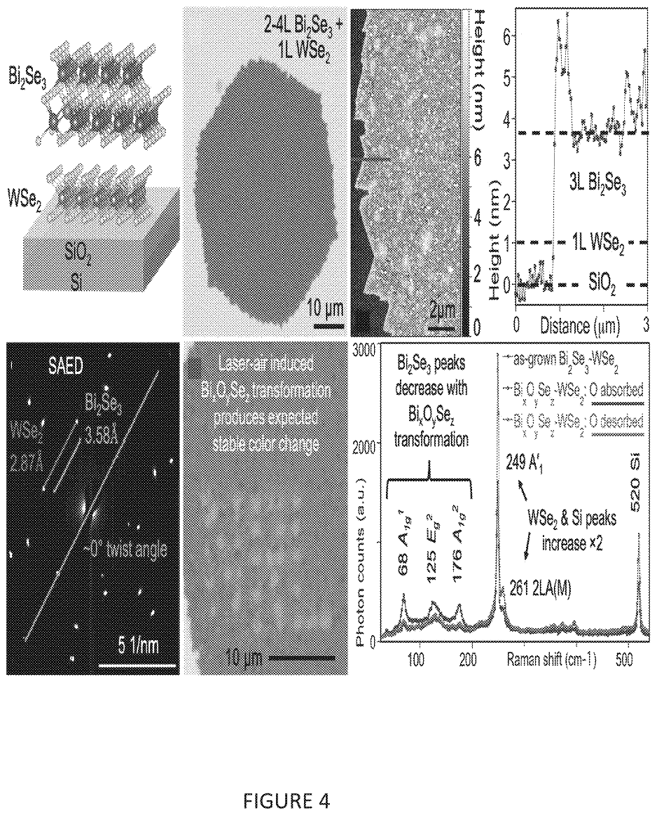

FIG. 4 demonstrates spatially-selective BixOySez-WSe2 2D heterostructure fabrication through laser exposure in air of a Bi2Se3-WSe2 2D heterostructure. Bi2Se3-WSe2 is grown using CVD, where monolayer WSe2 is first grown on SiO2/Si, followed by Bi2Se3 on top (see methods). FIG. 4 is a schematic and optical image, respectively, of as-grown Bi2Se3-WSe2 on an SiO2/Si substrate. FIG. 4 shows an atomic force measurement (AFM) scan and corresponding line profile, respectively, showing three layers of Bi2Se3 were grown on monolayer WSe2. FIG. 4 shows an SAED image of Bi2Se3-WSe2, where the well-formed spots suggest long-range crystallinity.

The Bi2Se3 grows at a near ~0° twist angle, suggesting material interaction is sufficiently strong to steer growth dynamics. FIG. 4 shows BixOySez-WSe2 patterned into Bi2Se3-WSe2 as the letters “NRL”, where the expected color change due to BixOySez is observed. FIG. 4 shows the Raman spectra of as-grown Bi2Se3-WSe2, as well as BixOySez-WSe2 with both oxygen absorbed and oxygen desorbed. In agreement with Figure, Bi2Se3 peaks decrease, suggesting the crystal is being altered during first laser-oxygen exposure. Conversely, WSe2 and Si peaks increase, suggesting the transmission increases. Although the PL intensity and peak position undergo dramatic shifts between the oxygen intercalated and deintercalated states (discussed later), no detectable change in Raman spectra is observed, suggesting PL modification is due to electronic changes at the interface, and not structural changes.

Numerous monolayer TMDs—including WSe2 and WS2—have a direct band gap and tightly-bound excitons, which facilitate a bright PL and strong light matter interaction. The monolayer nature enables the exciton's electric field lines to extend outside the material, making them sensitive to changes in the surrounding dielectric environment. Additionally, they lack an inversion center and contain spin-orbit coupling, enabling valley degree of freedom with valley-dependent optical selection rules, where different band structure valleys—and the spin-dependent excitons therein—can be selectively addressed using circularly polarized light. Together, they are promising materials for a spectrum of optoelectronic and advanced computing applications, including valleytronics, twistronics, spintronics, and quantum information sciences.

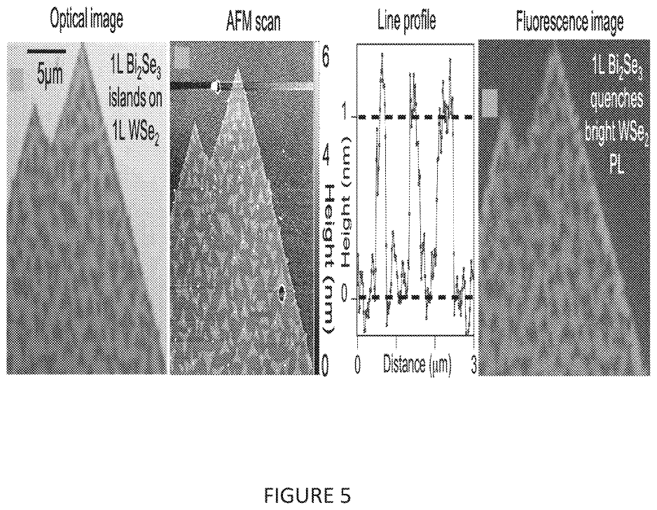

FIG. 5 shows growing one Bi2Se3 layer on monolayer WSe2 quenches the bright PL, suggesting the clean interface and a strong electronic coupling facilitates non-radiative exciton recombination. This is in agreement with theory calculations that predict hybridized states at the Gamma point facilitate a non-radiative decay pathway for carriers excited at K in WSe2. FIG. 5 is an optical image of monolayer Bi2Se3 triangular crystals grown on monolayer WSe2 on an SiO2 substrate. The well-formed triangular shapes suggest both materials are crystalline, in agreement with SAED measurements (FIG. 4). FIG. 4 is an AFM scan and corresponding line profile, respectively, showing the Bi2Se3 grew monolayer. FIG. 4 is a fluorescence image showing the PL intensity contrast between monolayer WSe2 and a Bi2Se3-WSe2 2D heterostructure. While monolayer WSe2 exhibits the expected bright PL, a single layer of Bi2Se3 quenches the PL nearly completely, behavior that has been observed in other Bi2Se3-TMD 2D heterostructures. Previous work suggests the strong interlayer coupling in Bi2Se3-TMD 2D heterostructures induces the formation of a pure electronic lattice at the interface, encouraging hybridization and non-radiative excitonic transitions.

We next showed that the WSe2 PL can be recovered by transforming Bi2Se3 into BixOySez, and intercalating oxygen into the interface.

We demonstrated BixOySez transformation (i.e., initial laser-oxygen exposure) restores the WSe2 PL, due to oxygen transport into the interlayer region, which decouples the materials, enabling radiative exciton recombination. We obtained optical and fluorescence images, respectively, of BixOySez patterned as the letters “NRL” into a Bi2Se3-WSe2 2D heterostructure using laser exposure in air, producing a purple-to-white color change and site-selectable WSe2 PL recovery with submicron (740 nm) resolution. We demonstrated PL spectra at multiple laser-air exposure times, revealing time-dependent evolution of the PL intensity, peak position, and spectra shape.

Our findings indicate BixOySez facilitates oxygen intercalation, which decouples the materials, enabling radiative exciton recombination in WSe2. The spectra contain a peak along with two shoulders, suggesting multiple radiative recombination pathways are present, possibly due to various exciton species and phonon side bands.

We measured the PL intensity and peak position evolution, respectively, where each data point is extracted using a robust fitting algorithm written in Python Spyder software, enabling low-error measurements. The spectra are fit with three Lorentzian functions and a linear background, where visual observation and low optimization uncertainty suggest a good fit. The PL intensity evolution is continuous, steadily increasing 43.8× over 342s (118 data points), demonstrating a continuum of PL values can be accessed. We believe the sporadic deviations (i.e., bumps or indentations that depart from an underlying order) are likely due to chemical and structural changes during the Bi2Se3 to BixOySez transformation. These deviations are not observed in follow-on oxygen deintercalation-intercalation cycles (discussed later). More specifically, in follow-on exposures the PL reliably modulates higher and lower, following Fick's 2nd Law of Diffusion closely. The PL peak position evolution rapidly decreases 23 meV and changes shape during the first 65s (23 data points), before plateauing and maintaining shape for the remainder of the exposure, a marked departure from the PL intensity evolution.

During the initial phase, the spectra shape appears to evolve from a single exciton fit into a multi exciton fit. The relative intensity, peak position, and FWHM for each Lorentzian evolve as well, thereby changing the spectra shape. Together, our findings suggest the exciton recombination pathways are modified as oxygen is intercalated. Previous work found monolayer WSe2 to have numerous exciton recombination pathways, as well as phonon side bands, which affect spectra shape. Supporting information contains two movies that use all the raw data to display the PL evolution. Control experiments of bare monolayer WSe2 (without BixOySez) under laser-air exposure showed only comparatively very minor changes over 6 min of exposure (<6% increase), demonstrating that BixOySez is required to modulate the TMD PL.

### Example 12

### Demonstration of Rapid Oxygen Diffusion at Room Temperature Under Laser Exposure.

We demonstrated that the PL can be repeatably manipulated higher and lower by intercalating and deintercalating oxygen, where diffusion speeds are atmosphere, pressure, and laser-power dependent. We show the PL intensity and peak position evolution, respectively, from a BixOySez-WSe2 2D heterostructure exposed to multiple atmospheres, pressures, and laser powers. The PL intensity and peak position evolution is dependent on oxygen partial pressure and laser power, which affect the direction and speed of diffusion.

The PL intensity (peak position) are modulated higher (lower) in an atmosphere containing oxygen, but modulated lower (higher) when no oxygen is present. The first laser-air exposure shows an uneven PL intensity curve, due to the Bi2Se3 to BixOySez transformation. In contrast, subsequent laser-atmosphere exposures follow Fick's 2nd Law of Diffusion closely, and without the sporadic deviations observed in the first laser-oxygen exposure. Changes to the peak position are also reversed, where the prominent rapid shift in peak position is consistently observed at low intensities. When sufficient oxygen is deintercalated, BixOySez couples to WSe₂, thereby strengthening certain higher-energy exciton recombination pathways.

We demonstrated that a continuum of PL values can be reliably accessed, suggesting the oxygen intercalation can be controlled with high precision. Fluorescence imaging suggests the changes are stable at room temperature in N2 for 221 days.

Together, the technology demonstrates spatially-selective and tunable intensities with write-read-erase-reuse capability and long-term stability.

Fick's 2nd Law of Diffusion—an equation used to describe the change in concentration with respect to time—fits the PL intensity data well, enabling diffusion coefficients to be extracted. We make the ansatz that the PL intensity is proportional to the concentration of oxygen in the interlayer region, and assume fixed concentration boundary conditions at the atmosphere and TMD. When applying boundary conditions, Fick's 2nd Law of Diffusion reduces to Eq. (1), where c is the concentration in the interlayer region, x is the BixOySez thickness, D is the diffusion coefficient, and t is the time. We set x=3 nm based on AFM data (FIG. 4):

$$c ( x , t ) = {c}_{air} - ( {c}_{air} - {c}_{initial} ) \frac{2}{\sqrt{π}} {\int }_{0}^{z} {e}^{- {y}^{2}} dy ; z = \frac{x}{2 \sqrt{Dt}} \qquad ( 1 )$$

Considering that the measurements were completed at room-temperature, the material demonstrates exceptionally fast diffusion, suggesting it is a promising low-temperature oxygen transporter for fuel cell applications. A low-temperature laser was used, and no temperature-dependent WSe2 response was detected, suggesting laser heating is minimal (<20 °C change), a conclusion supported by previous work on laser-induced heating in TMDs. For comparison, current SOFC technology operates in excess of 800 °C, which impedes wide-spread adoption.

We showed laser-power-dependent data replotted. Very low powers (0.636 μW) have no detectable effect, while low powers (6.26 μW) produce much slower diffusion compared to standard powers (27.0 μW). More specifically, lowering laser power 76.8%, slows desorption 76.5%. As the intensity plateaus toward low values, the PL peak position exhibits quasi-binary behavior, vacillating between the higher (1.605 eV) and lower (1.592 eV) energy states before remaining at the higher value. This behavior is also observed in the 1st and 2nd vacuum evolutions, suggesting the radiative recombination pathways and excitons undergo a notable change at the end.

We fabricated BixOySez on top of monolayer WS₂, and demonstrated that the WS2 PL intensity and peak position can be reversibly modulated higher and lower comparable to BixOySez-WSe₂, establishing that the effect is not confined to WSe₂.

After the initial laser-oxygen exposure, all subsequent exposures followed Fick's 2nd Law of Diffusion closely, suggesting the material's evolution under laser exposure is universal. Very notably, the independently measured diffusion constants are comparable to BixOySez-WSe¬2, despite the fact that the growth recipes and underlying TMDs were different, further validating our proposed mechanism, and the very fast diffusion speeds at room temperature. Previous works showed laser-air exposure of various Bi2Se3-TMD 2D heterostructures could increase PL intensity; however, the mechanism was not understood, and a chemical modification of Bi2Se3 was considered unlikely. Together, the BixOySez-WS¬2 experiments substantially reinforce our claims that BixOySez is a promising room-temperature oxygen transporter, and that it can be harnessed to precisely manipulate the properties of 2D materials in general—not just WSe2 and WS2.

The technology can be used to precisely manipulate their properties on the submicron scale, raising the possibility for spatially-selective and tunable magnetism, long-lived interlayer excitons, ferroelectricity, and integrated quantum photonics. Additionally, if the transport properties are modulated across equivalently large ranges, laser-written p-n junctions, neuromorphic computing schemes, and multistate optoelectronic devices are possible.

The PL evolution follows Fick's 2nd Law of Diffusion, enabling us to measure the oxygen diffusion speed through the BixOySez.

Our findings indicate oxygen diffuses very fast through BixOySez at room temperature under laser exposure (3.11e-18 m²s⁻¹), raising the prospect that it is a low-temperature oxygen ion conductor. Although other materials and Bi2O3 phases (e.g., 6-Bi2O3) have demonstrated much faster diffusion, they generally require temperatures in excess of 500 °C to be stabilized and efficiently operate, limiting material lifetime and greater adoption. Our measured BixOySez values are several orders of magnitude greater than other room-temperature oxygen transporters. A low-temperature oxygen ion conductor breakthrough would resolve the critical limitation of excessive SOFC operating temperatures, facilitating greater adoption of the technology and renewable energy.

### Explanation of Intercalation-Driven Photoluminescence, and Application to Other 2D Materials.

Raman data (FIG. 4) and optical microscopy images (FIG. 4) suggest that the structural change from Bi2Se3 to BixSeyOz occurs during the first laser-air exposure of the material and remains unchanged thereafter. In contrast, the PL intensity cycles with the amount of oxygen in the environment.

This suggests that the changes in PL are dependent on an interaction with oxygen that does not structurally alter either layer in the heterostructure.

This cycling behavior of the PL is consistent with oxygen intercalating and deintercalating from between the two layers, consistent with previous work. In the pristine Bi2Se3-WSe2, the WSe2 PL is quenched due to hybridization between the WSe2 valence bands and the Bi2Se3 conduction bands, leading to a non-radiative decay pathway for excited carriers in the WSe2. When oxygen is intercalated between the layers, the layers are physically separated, and the two layers no longer hybridize, suggesting a radiative decay pathway is primary. Supercells of zero-degree aligned Bi2O3-WSe2 bilayers are prohibitively large for computing similar band hybridization in the structurally altered heterostructures. However, the band alignment of Bi2O3 and WSe2 is qualitatively the same as the Bi2Se3-WSe2 band alignment, and the orbital weight at the conduction band minimum in both Bi2Se3 and Bi2O3 is on the Bi pz orbitals. Taken together, these facts suggest that the intercalation of oxygen between Bi2O3 and WSe2 layers would lead to similar changes in hybridization—and thus similarly changes in PL—as are seen in the pristine Bi2Se3/WSe2 heterostructure.

Oxygen transport membranes and oxygen ion conductors have been researched for decades, and there are numerous other materials. We have attempted to concisely summarize the important and applicable discoveries.

Bismuth oxide-based materials have been considered very promising and demonstrated success for decades across the globe; however, the research has focused on bulk bismuth oxide, which often needed to be stabilized using a substrate. Not only is our fabrication process unique, the nano-thin morphology represents a notable step forward.

Oxygen transport membranes are expected to play an important role for CO2 capture and syngas production, where several materials have been demonstrated, including Bi2O3, YxZyOz, Sc2O3, CeO2, and LaGaO3. These materials can also be doped to increase the oxygen transport speed or tailor their properties. Bi2O3 doped with metal oxides such as Y₂O₃, Gd2O3, Er2O3, Dy2O3, Nb2O5, and Ta2O5, become an oxygen transporter with significantly higher speeds.

In our system material, trace amounts of Se were detected, a novel discovery that raises the possibility the Se facilitates diffusion.

Typically, the prior art Oxygen transport membranes and oxygen ion conductors require very high temperatures, which greatly limits their adoption.

Here, we demonstrate that our material is able to rapidly transport oxygen at or near room temperature, suggesting it could have a notable impact on numerous technologies, including fostering renewable energy.

Of note, the oxygen transport is equivalently fast as other technologies at much higher temperatures (~500 °C), and several orders of magnitude as other room temperature oxygen transporters.

Oxygen Transport Membrane with a 2D Material.

The system is unique, and, to the best of our knowledge, no one has reported on combining an oxygen transport membrane with a 2D material. However, there have been other technologies that have manipulated 2D materials.

There are many advantages and new features disclosed herein.

Some examples of some advantages of this new material include, but are not limited to, the following.

The oxygen transport through the membrane functions at room temperature, which is ~800 °C less than SOFC electrolyte materials currently being applied, and ~500 °C lower than the ideal operating temperature where SOFC are expected to become cost competitive.

For example, lowering the temperature to less than 600 °C enables steel to be used for the interconnects, instead of high-temperature ceramics, greatly lowering cost and increasing resiliancy.

Another advantage includes the material is stable in ambient, whereas other leading oxygen transport membranes require high-temperatures to be stabilized.

Still another advantage includes the fabrication method is highly scalable, requiring only Bi2Se3 as a precursor and low-power laser or heat processing.

Furthermore, the nano-thin morphology allows it to be coupled to 2D materials, enabling oxygen transport into the interlayer region, and subsequent precision control of the interlayer coupling and 2D material properties.

The technology can be used to precisely manipulate their properties on the submicron scale, raising the possibility for spatially-selective and tunable magnetism, long-lived interlayer excitons, ferroelectricity, and integrated quantum photonics.

Additionally, if the transport properties are modulated across equivalently large ranges, laser-written p-n junctions, neuromorphic computing schemes, and multistate optoelectronic devices are possible.

Our technology enables our material to more easily interface with thin films and other nano technology, as it is more flexible and robust than bulk ceramics. Bulk ceramics are inflexible, and can be easily damaged in vibration environments.

The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

What we claim is:

1. A method of making a nano-thin BiₓO_{y}Se_{z} low-temperature oxygen transporter membrane, comprising:
providing an oxygen-containing environment;
providing a Bi₂Se₃ precursor film comprising a few-layers morphology within the oxygen-containing environment;
processing the Bi₂Se₃ precursor film with a laser in the oxygen-containing environment to systemically replace selenium lattice sites with oxygen until the selenium concentration is reduced to approximately 3 atomic percent (at. %) and the oxygen concentration is increased to approximately 84 atomic percent (at. %), thereby creating a structural transformation into a compound of BiₓO_{y}Se_{z} and R3̅m bismuth oxide (Bi₂O₃).

2. The method of making the nano-thin BiₓO_{y}Se_{z} low-temperature oxygen transporter membrane of claim 1,
wherein the step of processing the precursor film involves exposing the film to a low-power 532 nm laser having a power greater than 2.7 μW and a power density greater than 0.12 μW/m².

3. The method of making the nano-thin BiₓO_{y}Se_{z} low-temperature oxygen transporter membrane of claim 1,
wherein the resulting a standalone, single-phase film comprising an R3̅m crystal structure bismuth oxide (Bi₂O₃) lattice having trace residual selenium is configured to transport oxygen at room temperature.

4. The method of making the nano-thin BiₓO_{y}Se_{z} low-temperature oxygen transporter membrane of claim 3, further comprising the step of:
transferring the Bi₂Se₃ precursor film onto a suspended Transmission Electron Microscopy (TEM) grid structure prior to the step of processing with the laser; and
wherein the Bi₂Se₃ precursor film is initially grown on a sapphire substrate using Molecular Beam Deposition (MBD).

5. The method of making the nano-thin BiₓO_{y}Se_{z} low-temperature oxygen transporter membrane of claim 4,
wherein the step of processing with the laser occurs while the Bi₂Se₃ precursor film is suspended on the TEM grid;
and
wherein the resulting membrane comprises a thickness morphology ranging from 1-5 nm.

6. The method of making the nano-thin BiₓO_{y}Se_{z} low-temperature oxygen transporter membrane of claim 2,
wherein the step of processing with the laser induces an oxygen transport capability having a diffusion rate of approximately 3.11e-18 m²s⁻¹ at room temperature under the low-power laser exposure.

7. The method of making the nano-thin BiₓO_{y}Se_{z} low-temperature oxygen transporter membrane of claim 6,
wherein the resulting a standalone, single-phase film comprising an R3̅m crystal structure bismuth oxide (Bi₂O₃) lattice having trace residual selenium maintains structural stability and oxygen transport capacity in ambient atmosphere as a standalone film free of stabilizing dopants and free of a transition metal dichalcogenide (TMD) substrate layer.

8. The method of making the nano-thin BiₓO_{y}Se_{z} low-temperature oxygen transporter membrane of claim 1, further comprising the steps of:
combining the created a standalone, single-phase film comprising an R3̅m crystal structure bismuth oxide (Bi₂O₃) lattice having trace residual selenium with a target two-dimensional (2D) material or a monolayer transition metal dichalcogenide (TMD); and
selectively modulating properties of the target 2D material or TMD with submicron spatial resolution via localized oxygen transport from the compound.

9. The method of making the nano-thin BiₓO_{y}Se_{z} low-temperature oxygen transporter membrane of claim 8,
wherein the step of selectively modulating properties utilizes computer-controlled laser-patterning to govern the localized oxygen transport,
resulting in structural or electronic alterations in the target 2D material that remain stable for a duration exceeding 221 days.

10. The method of making the nano-thin BiₓO_{y}Se_{z} low-temperature oxygen transporter membrane of claim 9, further comprising the steps of:
regulating an interfacial oxygen exchange between the standalone, single-phase film comprising an R3̅m crystal structure bismuth oxide (Bi₂O₃) lattice having trace residual selenium and
dynamically modulating an electronic coupling between the membrane and the target 2D material,
wherein the alterations induced in the target 2D material are completely reversible upon a subsequent energy exposure.
